(19) United States
(12) Patent Application Publication
(10) Pub. No.: US 2025/0251245 A1
(43) Pub. Date: Aug. 7, 2025

(54) SYSTEM, METHOD, COMPUTER PROGRAM PRODUCT AND COMPUTER READABLE MEDIUM FOR SHARING AND RECEIVING A MAP-MATCHING RESULT

(71) Applicant: Commsignia Kft., Attala (HU)

(72) Inventor: Gergely György Regula, Budapest (HU)

(21) Appl. No.: 18/855,130

(22) PCT Filed: Apr. 11, 2023
(86) PCT No.: PCT/HU2023/050016

§ 371 Date: Oct. 8, 2024

(30) Foreign Application Priority Data
Apr. 8, 2022 (HU) P2200110

(51) Int. Cl. G01C 21/30

(52) U.S. Cl. CPC G01C 21/30

(57) ABSTRACT

A system for sharing a map-matching result is provided. The system comprises a map-matching module adapted for: receiving a digital map data from a map provider, receiving a location information, performing a map-matching on the received location information using the digital map data, and generating a map-matched location information. The system further comprises a map-matching result sharing module that is connected to the map-matching module. The map-matching result sharing module is adapted for receiving the map-matched location information from the map-matching module, and assembling a message including the map-matched location information as a map-matching result to be shared.

### TECHNICAL FIELD

The invention relates to a system for sharing a map-matching result and a method for receiving a shared map-matching result. The invention relates also to a computer program product and computer readable medium implementing the method.

The invention relates to Cooperative Intelligent Transportation Systems (C-ITS) that allows for communication between vehicles, infrastructure and other roadside units. This way of communication is also known as V2X (Vehicle-to-Everything). Radio and protocol implementations are not crucial for the V2X systems, thus the V2X systems can be implemented or integrated into any current or future systems.

Through V2X communication vehicles and other traffic participants can share information about the surrounding road topology and geometry, which fundamentally enhances their location and situation awareness. Furthermore, such shared information immediately improves the quality of decisions and the efficiency of filtering, i.e., selecting the relevant situations to be dealt with, such as a potentially dangerous situation.

Map-matching is a procedure to assign objects—for example, vehicles or other traffic participants—to locations on a digital map. Data obtained from a positioning system can naturally have uncertainties, thus matching the position of an object within the digital map results in a more accurate positioning and contributes to better situation awareness. This more accurate position information of objects with any geographical relevance can support movement prediction of a vehicle or any traffic participants, thus contributing to a more established decision-making.

Map-matching algorithms usually use inputs generated from positioning technologies (such as a Global Navigation Satellite System (GNSS), for the example Global Positioning System (GPS), a GNSS integrated with Dead Reckoning (DR) or with Real-Time Kinematics (RTKS)) and supplement these inputs with data from an accurate road network map to find an object's travel route. The general purpose of a map-matching algorithm is to identify the correct map object (e.g., a road segment) on which the vehicle or any other entity with geographical relevance is travelling (or standing) preferably based on past position data, and to determine a corrected or matched location of the vehicle or the other entity on that road segment. Therefore, map matching is a prerequisite of various location-based applications, such as navigation or vehicle tracking.

### BACKGROUND ART

There are several solutions for solving the map-matching problem. Based on the applied map-matching algorithm and the digital map, the result of map-matching can be different, which can lead to compatibility problems when results of map-matching are shared with other entities such as other vehicles or a road side unit (RSU).

US 2006/0224301 discloses a communication system between vehicles that transmits notifications about a moving body, such as a pedestrian or an other vehicle, to other drivers that cannot detect said moving body by themselves. The vehicles can communicate with each other either directly or via a vehicle control apparatus. The system includes a device for detecting a position of a moving body and a device for transmitting said position to other vehicles. The system also has a map-matching unit to match vehicle data with a map data memorized in a memory unit. Data received from other vehicles can be matched to a local map.

US 2022/0084399 A1 discloses a method, a system, a module and a software for intelligently governing a multi-way stop intersection. The purpose of the proposed method is to control the traffic flow near intersections. According to the document, a consensus method is used that may be based on, among other pieces of information, the sharing of lane level position of nearby vehicles. The shared information is then processed either in a distributed fashion or on a central entity and the solution is then broadcasted to individual participants of the traffic ecosystem, e.g., to other vehicles. When the method according to the document is performed in a distributed fashion, map-matching is performed on all entities arriving at a same intersection and if the remote entities share their map-matching results, it is only used for a cross-checking at a receiving entity. Therefore, the required computational capabilities on each entity are not reduced at all. Furthermore, the document focuses on how a consensus on a move order of the entities at the same intersection is achieved, and map-matching is merely an optional additional information source that can increase the quality of the decision.

US 2021/0039675 A1 discloses a path providing device and a path providing method thereof. Furthermore, the document discloses a scheme that can be used for path planning. The document describes several sub-modules and the interconnection and interaction thereof. According to the document, the traffic participants individually perform map-matching and may share the resulting information with each other via V2X messages. In addition, the document proposes a scheme for managing and handling digital map information simultaneously provided by different map providers and how these maps can be used for describing sub-sections of the proposed paths. A result of map-matching is only be shared among the modules within the on-board system, thus, such an information is not intended for a remote vehicle to be used neither for improved knowledge of the state of specific vehicles in its surroundings, nor to reduce the amount of computations required on its side.

In view of the known approaches, there is a need for a system and a method which allows for sharing location information between participants (entities) of a traffic ecosystem in an effective way that also reduces the computational needs of the participants.

### DESCRIPTION OF THE INVENTION

The primary object of the invention is to provide a system for sharing a map-matching result, which is free of the disadvantages of prior art approaches to the greatest possible extent.

A further object of the invention is to provide a method for receiving a shared map-matching result.

An object of the invention is further to provide a system and a method by the help of which a map-matching result calculated by an entity of a traffic ecosystem can be effectively shared and used by different entities.

Furthermore, the object of the invention is to provide a non-transitory computer program product for implementing the steps of the method according to the invention on one or more computers and a non-transitory computer readable medium comprising instructions for carrying out the steps of the method on one or more computers.

The objects of the invention can be achieved by the system according to claim 1. The objects of the invention can be further achieved by the method according to claim 13, the non-transitory computer program product according to claim 20, and by the non-transitory computer readable medium according to claim 21. Preferred embodiments of the invention are defined in the dependent claims.

It is known that map-matching is a computationally expensive problem, however it can highly increase the accuracy of ego-localization and also the accuracy of localizing other entities of the traffic ecosystem. Performing map-matching has the advantage that due to better localization, the traffic participants are more aware of their surroundings, thus, accidents can be avoided more effectively.

It has been recognized that if participants of the traffic ecosystem would share their map-matched localization information instead of their raw localization data, the overall computational needs could be drastically reduced, compared to a scenario wherein each participant performs map-matching on each received raw location information. The overall gain in terms of computational costs would be proportional to the number of entities sharing their map-matched locations within a receiving range of a receiving entity.

It also has been recognized that due to the existence of different map providers, the map-matching results of different entities needs to be harmonized/consolidated. The main advantage of the system and method according to the invention that map-matching results calculated based on map data provided by different map providers can also be effectively used.

### BRIEF DESCRIPTION OF THE DRAWINGS

Preferred embodiments of the invention are described below by way of example with reference to the following drawings, where

FIG. 1 is a block diagram showing a process of sharing map-matching results of an ego-vehicle,

FIG. 2 is a block diagram showing another process of sharing map-matching results of an ego-vehicle,

FIG. 3 is a block diagram showing a process of sharing map-matching results by an infrastructure element, and

FIG. 4 is a block diagram showing a process of receiving map-matched information from an other entity.

### MODES FOR CARRYING OUT THE INVENTION

This invention relates to a system that enables traffic participants to share map-matching results with other traffic participants including but not limited to vehicles, vulnerable road users (VRUs) such as cyclists, pedestrians, and any part of the traffic infrastructure.

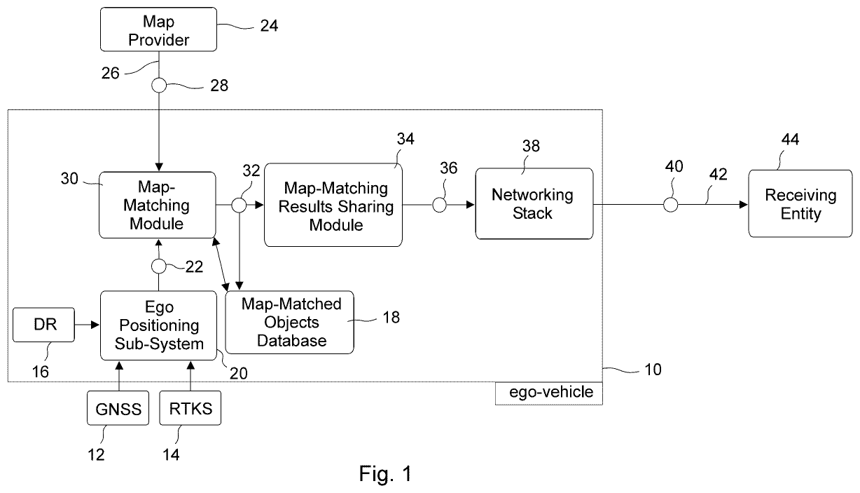

FIGS. 1 to 4 show block diagrams showing examples of the system according to the invention.

The system according to the invention may contain the following components or functional blocks.
Map provider 24: An entity that is adapted for providing digital geographical services for its clients. The map provider 24 can preferably be accessed via a data communication channel 26, 26′, wherein the data communication channel 26, 26′ is a wired or wireless connection, for example, a wired or wireless internet connection. The map provider 24 can be hosted by multi-access edge computing (MEC), in a cloud or on one or more traditional servers. The map provider 24 preferably provides a map once to the clients, or the map can be updated via the data communication channel 26, 26′ regularly or on demand.
Ego positioning sub-system 20: A functional module that is adapted for computing a geographical location of a hosting vehicle (i.e., an ego-vehicle 10). The ego positioning sub-system 20 combines input from various low level location services like a GNSS 12 (Global Navigation Satellite System), an RTKS 14 (Real Time Kinematic System) and a DR (Dead Reckoning) algorithm 16 to compute a high precision location of the ego-vehicle 10.
Map-matching module 30: A functional module of the system according to the invention that performs map-matching. The map-matching can be performed with any map-matching algorithm known in the art.
Map-matching result sharing module 34: A functional module that takes the results of a map-matching and assembles a message 36, 36′, e.g., a map-matching results sharing message. The map-matching results sharing message can include one or more pieces of the following data:
an identifier of a matched object, e.g., a station ID of a matched vehicle,
an identifier of the matched map object, e.g., a road segment,
a corrected location of a traffic participant entity being map-matched, e.g., a location of a vehicle projected on the matched road segment, and
an identifier of a map provider 24.

Preferably, the map-matching result sharing message contains all the above data. In some preferred embodiments the map-matching results sharing message may contain further data.
Networking stack 38: A functional module that is adapted for communicating on one or more networking protocols. The networking stack 38 preferably provides networking services for the map-matching result sharing module 34.
Receiving entity 44: An entity that is adapted for receiving a map-matching results sharing message. As an example, the receiving entity 44 can be the ego-vehicle 10, a remote vehicle 46, an infrastructure element 62 (such as an RSU (Road Side Unit), a MEC server, a cloud server, a Traffic Control/Management Center), etc.
Remote entity: An entity of the traffic ecosystem that can share its position with other entities of the same ecosystem. A remote entity can be an other vehicle such as a remote vehicle 46, or an RSU, etc.
Map-matching result sharing entity 60: An entity of a traffic ecosystem that shares its map-matching algorithm results with other entities of the same ecosystem. The map-matching result sharing entity 60 can be a remote entity, for example a remote vehicle 46. The map-matching result sharing entity 60 can also be the ego-vehicle 10.
Map-matching result verification module 52: A functional module of a receiving entity 44. The map-matching result verification module 52 is adapted to handle a received map-matching results sharing message.
Map-matched objects database 18, 18′: A data storage module that can be used by a receiving entity 44 (or by the ego-vehicle 10) to store information extracted from a map-matching results sharing message.
Map consolidation API 58: A network communication interface and a corresponding protocol implementation that can be used by a receiving entity 44 to consolidate a received map-matching result (e.g., a map-matching results sharing message) that was generated based on another map provider's (for example a second map provider's 56) data than the receiving entity 44.

FIG. 1 shows an exemplary system that can be used for sharing map-matching results of an ego-vehicle 10. According to FIG. 1, the ego-vehicle 10 shares its own map-matched information to other traffic participants. The benefit of this is that the other traffic participants do not have to map-match the ego-vehicle 10, just receive and process the shared results, therefore the other traffic participants can reduce their computational needs.

The ego-vehicle 10 preferably receives digital map data 28 or a digital map dataset form a map provider 24. Preferably, there is a data communication channel 26 between the map provider 24 and the ego-vehicle 10, wherein the data communication channel 26 has a wired or wireless connection, for example, a wired or wireless internet connection.

The ego-vehicle 10 preferably uses a GNSS 12 (Global Navigation Satellite System), RTKS 14 (Real Time Kinematic System), a DR (Dead Reckoning) algorithm 16, more preferably an on-board DR algorithm, or any other method or combination of these to compute a geographical location of the ego-vehicle 10 (ego-vehicle position 22). The ego-vehicle position 22 and the digital map data 28 is provided for the map-matching module 30. Preferably, the map-matching module 30 receives actual and historical data of the ego-vehicle position 22. The map-matching module 30 finds a best matching map object (e.g., a road segment) and computes a corrected location of the ego-vehicle 10. The corrected location of the ego-vehicle 10 is an ego-vehicle map-matching result 32 that is sent from the map-matching module 30 to a map-matching result sharing module 34. The map-matching result sharing module 34 preferably collects further additional pieces of information, and assembles a message 36, preferably a map-matching results sharing message, that can include one or more pieces of the following data:
an identifier of a matched object, e.g., a station ID of a matched vehicle,
an identifier of the matched map object, e.g., a road segment,
a corrected location of a traffic participant entity being map-matched, e.g., a location of a remote vehicle 46 projected on the matched road segment, and
an identifier of the map provider 24.

Preferably, the message 36 contains all the above data. In some preferred embodiments the message 36 may contain further data.

In the case according to FIG. 1, the identifier of the matched object is the identifier of the ego-vehicle 10, e.g., a C-ITS Station ID. The map-matching result sharing module 34 is adapted to request a networking stack 38 to send out an assembled message 40. Preferably, the assembled message 40 can be shared over multiple communication channels simultaneously.

The map-matching results are preferably stored in a map-matched objects database 18. Preferably, once the map-matching module 30 has computed the ego-vehicle map-matching result 32, the ego-vehicle map-matching result 32 is passed to the map-matched objects database 18.

The map matching results sharing message can be implemented either as an extension of an existing, standardized V2X message such as a Cooperative Awareness Message (CAM) or a Basic Safety Message (BSM), a Collective Perception Message (CPM), or as a new standard message type or a proprietary message. The ego-vehicle 10 can preferably send out the map-matching results sharing message in several message formats simultaneously, for example via multiple communication channels.

The process according to FIG. 1. is preferably performed repeatedly. For example, each time the ego-vehicle position 22 is updated, or a change occurs in the digital map data 28, the process according to FIG. 1 is activated, and a new map-matching metadata is computed and a new message including a new map-matched information is shared.

Alternatively, the repetition of the process according to FIG. 1 can be determined for example based on a speed of the ego-vehicle 10. At a lower speed a lower messaging frequency can be used for sharing the message 40, at a higher speed or at high acceleration/deceleration of the ego-vehicle 10 a higher messaging frequency can be used. This allows for more frequent updates when the position of the ego-vehicle 10 can change more rapidly, or when a dangerous situation is expected (i.e., when there is a harsh braking or a high deceleration).

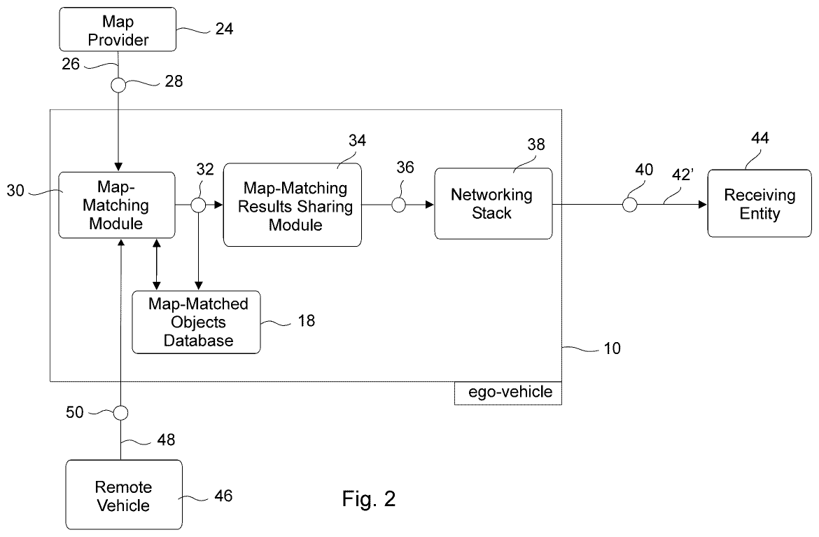

FIG. 2 illustrates a system, wherein a remote vehicle 46 shares its map-matching results with the ego-vehicle 10.

Similar to the process described in connection with FIG. 1, any traffic participant can perform map-matching on other traffic participants instead or besides of map-matching its own position. This enables map-matching of remote vehicles 46 that do not perform ego-vehicle map-matching and thus cannot share such information about themselves.

According to FIG. 2, an ego-vehicle 10 preferably receives remote vehicle position 50 from a remote vehicle 46. The remote vehicle 46 is preferably connected to the ego-vehicle 10 via a data communication channel 48, more preferably a wireless data communication channel to transfer information about the remote vehicle 46 to the ego-vehicle 10.

The remote vehicle position 50 is preferably fed into the map-matching module 30 of the ego-vehicle 10 along with a digital map data 28 received from a map provider 24. The map matching module 30 preferably can consult with a map-matched objects database 18 of the ego-vehicle 10, via a bi-directional connection between the map-matching module 30 and the map-matched objects database 18 to check whether there is map-match context already available for said remote vehicle 46.

If map-matched data corresponding to said remote vehicle 46 is already contained in the map-matched objects database 18, the map-matched data corresponding to the remote vehicle 46 can use this stored data.

If previously no map-matching has been performed on the remote vehicle 46 or the previously map-matched information about the remote vehicle 46 is outdated, the map-matching module 30 performs the map-matching of the remote vehicle 46, and the result of the map-matching is preferably stored in the map-matched objects database 18 or the corresponding data can be updated with the newly performed map-matching.

Similar to FIG. 1, the output of the map-matching module 30, i.e., the map-matching result 32 can be either stored in the map-matched objects database 18 or can be forwarded to the map-matching result sharing module 34. The map-matching result sharing module 34 creates a message 36 or an assembled message that is forwarded to a networking stack 38. The networking stack 38 transmits a message 40 containing map-matched information regarding the remote vehicle 46 and/or the ego-vehicle 10 to a receiving entity 44, wherein the receiving entity 44 can be the remote vehicle 46, an other vehicle, an RSU or any other participant of the traffic ecosystem. The networking stack 38 preferably communicates the message 40 via a data communication channel 42′, wherein the data communication channel 42′ is preferably a wireless communication channel. The networking stack 38 is preferably adapted to communicate via different predetermined data communication channels 42′ simultaneously.

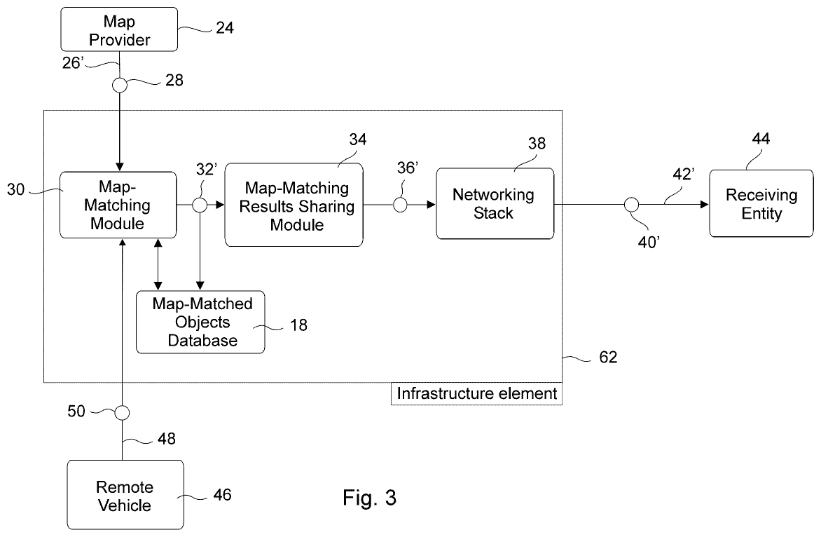

FIG. 3 shows an embodiment of the system according to the invention, wherein the calculating entity is an infrastructure element 62 such as an RSU or a map-matching service running on a MEC (Mobile Edge Computing) or a cloud server.

The infrastructure element 62 is preferably a static entity that does not move; thus, it is not necessary to perform map-matching on itself, but the infrastructure element 62 can perform map-matching on a remote vehicle 46, similar to the example shown in FIG. 2.

According to FIG. 3, the infrastructure element 62 is preferably adapted to receive a remote vehicle position 50 from a remote vehicle 46. The remote vehicle 46 preferably transmits the remote vehicle position 50 to the infrastructure element 62 via a data communication channel 48, preferably a wireless communication channel.

Similar to FIG. 2, the infrastructure element 62 has a map-matching module 30 that receives the remote vehicle position 50 from the remote vehicle 46. The map-matching module 30 of the infrastructure element 62 also receives digital map data 28 from a map provider 24, preferably via a data communication channel 26′, wherein the data communication channel 26′ is preferably a wireless communication channel.

The infrastructure element 62 preferably also includes a map-matched objects database 18 that is preferably similar to the map-matched objects database 18 of FIG. 2. The map-matched objects database 18 and the map-matching module 30 are preferably in a bi-directional connection that allows the map-matching module 30 to use data from the map-matched objects database 18 and map-matched data (e.g., a map-matching result 32′) from the map-matching module 30 can be stored in the map-matched objects database 18.

Besides storing the map-matching result 32 in the map-matched objects database 18, the map-matching result can be forwarded to the map-matching result sharing module 34. The map-matching result sharing module 34 creates a message 36 or an assembled message that is forwarded to a networking stack 38. The networking stack 38 transmits a message 40 containing map-matched information regarding the remote vehicle 46 and/or the ego-vehicle 10 to a receiving entity 44, wherein the receiving entity 44 can be the remote vehicle 46, an other vehicle, an RSU or any other participant of the traffic ecosystem. The networking stack 38 preferably communicates the message 40 via a data communication channel 42′, wherein the data communication channel 42′ is preferably a wireless communication channel.

The networking stack 38 is preferably adapted to communicate via different predetermined data communication channels 42′ simultaneously.

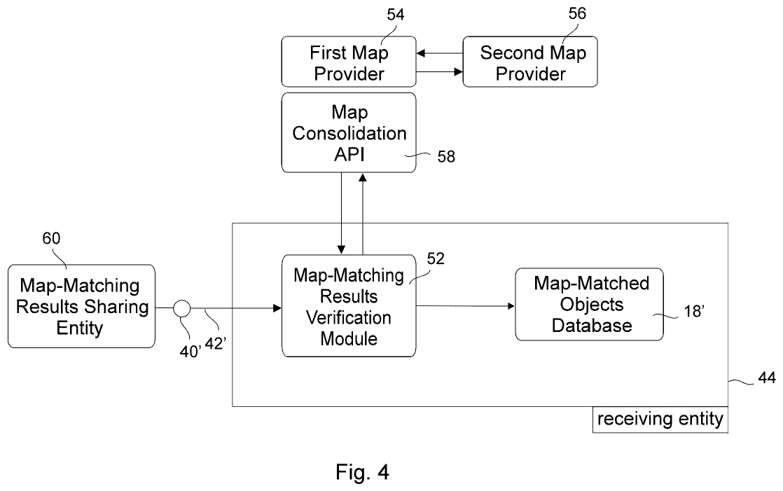

When a receiving entity 44 receives map-matched information, preferably in a form of a message 40′, from a map-matching result sharing entity 60, the received information needs to be processed. FIG. 4 shows a preferred arrangement for verifying and consolidating map-matching results received from a map-matching result sharing entity 60. The map-matching result sharing entity 60 is preferably a remote vehicle 46.

The receiving entity 44 preferably first checks whether a map provider 24 of the map-matching result sharing entity 60 is the same as its own map provider 24. The receiving entity 44 preferably has a map-matching result verification module 52 to compare the map provider 24 of the receiving entity 44 and the map provider 24 of the map-matching result sharing entity 60. According to the example shown in FIG. 4, the map provider 24 of the receiving entity 44 is a first map provider 54, the map provider 24 of the map-matching results sharing entity is a second map provider 56.

In cases when the first map provider 54 and the second map provider 56 are the same, the received map-matching results can be directly used by the receiving entity 44, e.g., the received map-matching results can be saved and stored in a map-matched objects database 18′ for further use. The map-matched objects database 18′ preferably checks if there is an existing entry for the map-matching result sharing entity 60 and/or the map-matched object that the map-matching result sharing entity 60 was sending information about. In case of an existing entry, data relating to the existing entity is updated, otherwise a new entry is created in the map-matched objects database 18′ for the map-matching result sharing entity 60 and/or said map-matched object.

In cases when the first map provider 54 and the second map provider 56 are not the same, the receiving entity 44 needs to consolidate the received information, i.e., the received information provided in the context of the second map provider 56 is to be interpreted in the context of the first map provider 54. Said consolidation is preferably carried out by a map consolidation API 58. The process of consolidation is described later on.

Consolidation means that a received map object identifier is translated into the digital map representation of the map provider 24 used by the receiving entity 44. The map-matching result verification module 52 consults with its map provider 24 (a first map provider 54) through the map consolidation API 58 and requests the translation of the remote map data source identifier received. Alternatively, the receiving entity 44 may perform the consolidation using its own resources, with the aid of auxiliary information shared by the map-matching result sharing entity 60.

The map-matching results reception might be governed by a classification and prioritization module (not shown) that tells which object must be map-matched on-board and from which objects map-matching results are accepted.

Typically, different map providers 24 provide different digital maps for their users, which can make it difficult to evaluate position data that has been generated or map-matched by using a different digital map. The most common differences between two digital maps can be any of the following:
Difference between the level of detail. E.g., standard definition (SD) maps usually only contain vague information about the lanes within a road or do not contain information about the lanes at all, while high definition (HD) maps normally include information about exact boundaries of each lane.
Topological differences. E.g.:
   In certain cases, some (usually lower level) roads are completely missing from one map, while a different, more detailed map includes these roads as well.
   There is no common rule on how roads should be split into shorter parts (also known as links). A road may be split in one map based on attributes like a change in the speed limits or around specific traffic signs, while another map may have a maximum number of intermediate points between two endpoints, etc.
   Roads may or may not be updated in a timely manner at certain locations in digital maps.
   Some maps can filter out certain roads that are considered irrelevant for a user.
Differences in road geometry. E.g., different map providers 24 typically use different techniques for collecting data about the geometry of a road, which results in differences in the actual geometry of the road.

There are technical solutions to forwarding a current position of a vehicle (or in general, an entity) and a heading (i.e., a direction that the vehicle moves towards). This information, i.e., the current position and the heading are usually forwarded as a part of CAM or BSM messages. However, the information originally included in these messages are not sufficient to identify—at a high probability—a road or road segment on which an entity is travelling. For this reason, there would still be a need to perform map-matching on the receiving entity 44 to localize a sharing entity (e.g., a remote vehicle 46 or a remote entity) on its own map. It is to be noted, that if the sharing entity and the receiving entity does not use a same or a compatible map, then even if map-matched location information is shared by the sharing entity, it needs to be map-matched against the map of the receiving entity 44, which increases the computational needs of the receiving entity 44.

The method according to the invention provides a solution to consolidate maps used by different entities of the traffic ecosystem and thus reduces the computation burdens on the receiving entities 44. The method according to the invention allows for identifying a road a remote vehicle 46 is travelling on.

Digital maps provided by any map provider 24 usually comprise nodes and links between the nodes. A node of a digital map can be an intersection, such as a junction, i.e., a vertex in a road topology graph that has at least three connecting edges (for example, T- or Y-junctions, intersections, roundabouts etc.). These nodes can be called junction nodes. If a road or road segment is missing from a map, then a corresponding junction node can be missing as well.

Further nodes can also be defined between the junction nodes, for example, at predetermined intervals in-between, or at predefined traffic signs, or where a new lane starts or where a lane ends, etc.

A link is preferably an edge of a graph representation of a road structure that is arranged between the nodes. For example, a link can be a road segment between two nodes.

A “straight extension” of a link is defined by the following in connection with the present invention. First, an initial link is selected. A link always has two end nodes delimiting the link. Starting from one of the end nodes of the initial link, a connecting road segment is searched for, i.e., a link (a connecting link) that has a common end node with the initial link and that also points to a same direction as the initial link. Same direction means that the difference in directions of the initial link and the connecting link is within a threshold angle (e.g., 20 degrees). When a connecting link is found, starting from its end node (that is the common end node) further connecting nodes are searched for, until no more connecting link is found that fits the criteria for a connecting link or until a predetermined number of connecting links is reached. The process for searching for connecting links is repeated starting from the other end node of the initial link in the opposite direction. At the end, this process results in an ordered set of connecting links.

The method according to the invention can be applied to any actors (vehicles, bicycles or motorcycles, pedestrians etc.) participating in traffic or transport. Therefore, in the present description, these are called entities.

Furthermore, the terms “ahead” and “behind” are defined the following way in the context of map-matching. The terms “ahead” and “behind” are to be interpreted relative to a motion of a map-matched entity. Within a digital map, a geometry of a link is described by a series of points between a start node and an end node. However, an entity may move along both (opposing) directions, hence a node that a map-matched entity is approaching is a node “ahead”, while the other node of the link is a node “behind”.

It is to be noted that an entity may start its journey somewhere between the two end nodes of a link (for example, because it parked there for a while or entered the link (the road) from outside the road structure described in the map, e.g., from a road not present in the map). Furthermore, when straight extensions are created, the result may contain links that the map-matched entity has not even driven along.

An example of the method according to the invention is described below. An enumerated type of variable is defined that collects all the known map providers 24 and all their known services; an identifier is defined for each map provider 24 and each of their service, wherein the identifier is preferably a map data source identifier. The map data source identifier can be used as a guide for a receiving entity 44 to determine whether the map of a remote entity is compatible with its own map. Once receiving a map data source identifier of the remote entity (a remote map data source identifier), it is compared to the map data source identifier of the receiving entity 44 (a local map data source identifier). If the remote map data source identifier is compatible with the local map data source identifier, i.e., a matching exists between a remote map corresponding to the remote map data source identifier and a local map corresponding to the local map data source identifier, the map data or map-matched data of remote entity can be translated to the local map, i.e., map-matching results of the remote entity can be applied directly, without any further steps by the receiving entity 44. Besides the map data source identifier, the message shared by the remote entity may further include a result of the map-matching of the remote entity (e.g., a link identifier and optionally, a lane identifier of a lane on which the remote entity currently resides). If the results are shared within a separate message that already contains the location of the remote entity (e.g., in a form of a BSM/CAM), then the message can also include a current position of the remote entity, in order to allow it to be used by the receiving entity 44 for lane-level localisation.

In a preferred embodiment, besides the remote map data source identifier, the optional link identifier and lane identifier, information about a straight extension of the map-matched link can also be shared by the remote entity, preferably via a message. A preferred way for extracting a straight extension of an initial map-matched link has already been described above. Preferably, a location of the nodes ahead and the nodes behind can also be shared via the message. Data of the location of the nodes ahead and the nodes behind are preferably stored in a local digital map in a custom container involving two lists, i.e., one list for the location of the nodes ahead and a second list for the location of the nodes behind. The number of nodes in both lists is preferably limited to a predefined maximum number N and M, respectively, and even more preferably, each list is ordered based on a distance along a road from the map-matched entity, e.g., the remote entity. Each list preferably contains the nodes in an ascending order based on the distance on the road from the map-matched entity. Thus, preferably a first node in the list of nodes ahead is a closest node (e.g., a junction node) towards a direction in which the remote entity is headed and a first node in the list of nodes behind is a closest node (e.g., junction node) in an opposite direction. Depending on the remote map, the remote entity (i.e., the entity sharing its map-matching results) might not fill both lists to their full capacity if a smaller number of nodes ahead and/or nodes behind can be found. Preferably, the remote vehicle 46 stores the two lists of the nodes ahead and the nodes behind in its memory, especially when the two lists are fully populated.

As an illustrative example, a set of changes that can be applied to a current European (ETSI EN 302 637-2 V1.4.1) and US (SAE J2735-202007) standard message container for map-matching result sharing is shown in Listings 1 to 3. The pseudo-codes below intend to present possible ways of integration of map-matching results into already existing message types. Data elements are grouped into various containers that build up the standard messages. Additional elements compared to the standard messages are marked by italic. The message structures are displayed till a level where map-matching result containers are added to an already existing container of the standard messages.

Data types of the fields are usually design parameters and are typically chosen as the minimum size that can accommodate the extreme values of the given field, in order to make a balance between performance and message size. Occasionally, the fields are dynamically sized based on a current content. Therefore, the listings below contain only coarse/generic type names that are meant to reflect the underlying type of the corresponding fields.

According to the examples shown below (listings 1-3) the MapMatchingResult container has a field that identifies a map data source (mapDataSourceId) that a remote entity uses for map-matching. The result of the map-matching, preferably including a matched link (an identifier of the matched link) is also included in the MapMatchingResult container. The matched link is preferably interpreted together with the mapDataSourceId.

Additionally, the nodes ahead and the nodes behind can be stored in fields nodesAhead and nodesBehind, respectively, preferably in an array-like container (or in a list), wherein a size of the array-like container may vary and/or the array-like container has a maximum capacity. Elements of the array-like container storing are preferably used for storing a location corresponding to the nodes ahead and the nodes behind. The fields can be implemented by any other known solution in the art, for example, by data lists.

It is to be noted that Cooperative Awareness Messages (CAM) (usually used in the European Union) and Basic Safety Messages (BSM) (usually used in the United States of America and China) already contain an absolute position (a location of the sharing entity). Therefore, it is preferred to store map-matched location data in different data fields, for example, as offset values. This also helps keeping the messages (CAM and/or BSM) as concise as possible. In a preferred embodiment, each element of the node lists may be interpreted relative to a reference position value, i.e., the absolute position contained within the respective message. Said reference position can also be used as a reference for the location information of the nodes ahead and the nodes behind. Position information of successive elements of the lists of the nodes ahead and the nodes behind may also be interpreted relative to a previous position in the respective list. As an example, the fields MapNodeDeltaPosition MapNodeDeltaPositionList follow this convention.

Listings 2 and 3 show in which container the map-matching results may fit in an implementation. In case of CAM messages, a MapMatchingResultContainer can be arranged into a CamParameters container as shown in Listing 2. In case of BSM messages, a field with a similar type may be placed into the SupplementalVehicleExtensions being part of a BSM message (see Listing 2). For compatibility reasons, it is preferred to place new elements, and new containers between a last field specified by the standards and custom elements that can host any custom content not governed by the standards (e.g., indicated by “<custom fields>”).

Listing 1. An example of a structure of a map-matching result container.

| 1. | MapNodeDeltaPosition { | |
|---|---|---|
| 2. | latitudeOffset: | integer |
| 3. | longitudeOffset: | integer |
| 4. | elevationOffset: | integer (OPTIONAL) |
| 5. | } | |
| 6. | | |
| 7. | MapNodeDeltaPositionList: Array of MapNodeDeltaPosition | |
| 8. | | |
| 9. | MapMatchingResult { | |
| 10. | mapDataSourceId: | integer or enumerated type |
| 11. | matchedLinkId: | integer |
| 12. | nodesAhead: | MapNodeDeltaPositionList |
| 13. | nodesBehind: | MapNodeDeltaPositionList |

| | |
|---|---|
| 14. | } |

Listing 2. An example of inputting map-matched data fields into a CAM message.

| 1. | CamParameters { | | |
|---|---|---|---|
| 2. | highFrequencyContainer: | HighFrequencyContainer | |
| 3. | lowFrequencyContainer: | LowFrequencyContainer | (OPTIONAL) |
| 4. | specialVehicleContainer: | SpecialVehicleContainer | (OPTIONAL) |
| 5. | mapMatchingResultContainer: | MapMatchingResultContainer | (OPTIONAL) |

| | |
|---|---|
| 6. | <custom fields> |
| 7. | } |

Listing 3. An example of inputting map-matched data fields into a BSM message.

| 1. | SupplementalVehicleExtensions { | | |
|---|---|---|---|
| 2. | classification: | BasicVehicleClass | (OPTIONAL) |
| 3. | classDetails: | VehicleClassification | (OPTIONAL) |
| 4. | vehicleData: | VehicleData | (OPTIONAL) |
| 5. | weatherReport: | WeatherReport | (OPTIONAL) |
| 6. | weatherProbe: | WeatherProbe | (OPTIONAL) |
| 7. | obstacle: | ObstacleDetection | (OPTIONAL) |
| 8. | status: | DisabledVehicle | (OPTIONAL) |
| 9. | speedProfile: | SpeedProfile | (OPTIONAL) |
| 10. | theRTCM: | RTCMPackage | (OPTIONAL) |
| 11. | mapMatchingResult: | MapMatchingResult | (OPTIONAL) |
| 12. | regional: | Array of RegionalExtension | (OPTIONAL) |

| | |
|---|---|
| 13. | <custom fields> |
| 14. | } |

A preferred implementation of the method according to the invention is described below in detail. As it is seen in FIG. 4, a receiving entity 44 receives a message containing information about a position of a remote entity. Preferably, on the receiving entity 44, the algorithm applied to the content of the map-matching sharing container is less expensive than performing map-matching either on the remote entity 46 or on the receiving entity 44.

The message received by the receiving entity 44 is preferably a CAM or a BSM message. The message preferably contains a remote map data source identifier corresponding to a remote digital map used by the remote entity, and a link identifier. The message is received by a receiving entity 44 that preferably has a local map data source identifier corresponding to a local digital map used by the receiving entity 44.

After receiving the message, the receiving entity 44 compares the remote map data source identifier with the local map data source identifier. If the remote map data source identifier is compatible with the local map data source identifier, the link identifier is returned corresponding to the map-matching results shared by the remote entity. Compatibility between the remote map data source identifier and the local map data source identifier means that the received position data can be directly interpreted and used by the receiving entity 44. In this case the further method steps can be skipped.

If the remote map data source identifier is not compatible with the local map data source identifier, a node distance threshold value is defined by the receiving entity 44. A node in the remote digital map and a node in the local map is preferably considered as equivalent if a distance between the node in the remote digital map and the node in the local map is less than the node distance threshold value. Furthermore, a link distance threshold value is defined. A point is considered to be on a link within the local digital map if its distance from a broken line defined by consecutive, connected links is below the link distance threshold value.

In a further step, a set of candidate links is compiled by selecting links near the location of the remote entity using the position information within the received message. If bounding boxes around the links are stored in the local digital map, using the bounding boxes can accelerate the compilation of the set of candidate links.

In a further step, a distance between the remote entity and the set of candidate links is calculated, and preferably the set of candidate links is arranged in an ascending order. Preferably, links from which a distance of the remote vehicle is larger than or equal to the link distance threshold value are eliminated from the set of candidate links, and only the links to which the remote entity is closer than the link distance threshold value are kept in the set of candidate links.

In a further step, an iteration is carried out through the set of candidate links and it is checked if the two end points of the current candidate link have an equivalent in the lists of nodes ahead and nodes behind in the map-matching container of the received message. If a matching link is found, the later steps are skipped and the current link is returned as the matching result.

In a further step, an iteration is carried out through the set of candidate links and the following sub-steps are performed:
The end points of a current candidate link are classified as a local node ahead or a local node behind based on the direction of motion of the remote vehicle 46.
A straight extension of the current candidate link is generated according to the directionality defined in the previous sub-step.
An iteration is run through the nodes of the set of straight extension and it is checked whether any of the local nodes ahead and any of the local nodes behind have an equivalent in the lists of nodes ahead and nodes behind in the map-matching container of the received message, respectively. If a matching link is found, the following steps are skipped and the current candidate link is returned as the matching result.
(Optional) An iteration is run through the nodes within the map-matching container of the received message and it is checked if any of the elements of the lists of nodes ahead and nodes behind lie within the link distance threshold value from the links in the straight extension of the current candidate link. If a match is found, the current candidate link is returned as the matching result. This optional sub-step is preferably only performed if a default map-matching algorithm used in a general situation requires considerably more effort than performing this sub-step.

If none of the previous steps return a matching result, it means that no correspondence has been found between the local digital map and the remote map-matching result. Therefore, the remote entity needs to be map-matched against the local digital map by any map-matching algorithm available at the receiving entity 44.

A second exemplary implementation of the method according to the invention is described below. The method below has a higher success rate of matching received location information within a local digital map.

Furthermore, the main difference between the two is that instead of returning the first matching candidate link as the result, the second exemplary implementation selects the candidate link that is the “most similar” to the shared data. The similarity is measured by a cost function; implementation of the cost function can be application-specific.

According to this example, a receiving entity 44 receives a message containing information about a position of a remote entity. The message received by the receiving entity 44 is preferably a CAM or a BSM message. The message preferably contains a remote map data source identifier corresponding to a remote digital map used by the remote entity, and a link identifier. The message is received by a receiving entity 44 that preferably has a local map data source identifier corresponding to a local digital map used by the receiving entity 44.

The method comprises the following steps.
1. Compare the map data source identifier with the local map data source identifier. If the remote map data source identifier is compatible with the local map data source identifier, return the link identifier corresponding to the map-matching results shared by the remote entity. Compatibility between the remote map data source identifier and the local map data source identifier means that the received position data can be directly interpreted and used by the receiving entity 44. In this case the further method steps can be skipped.
2. If the remote map data source identifier is not compatible with the local map data source identifier, a node distance threshold value is defined. A node in the remote digital map and a node in the local map is considered as equivalent if a distance between the two is less than this threshold value. Furthermore, a link distance threshold is defined. A point is considered to be on a link within the local digital map if its distance from a broken line defined by consecutive, connected links is below the link distance threshold value.
3. Compile a set of candidate links by selecting links near the location of the remote entity using the position information within the message. If bounding boxes around the links are stored in the local digital map, using the bounding boxes can accelerate the compilation of the set of candidate links.
4. Calculate a distance between the remote entity and each element of the set of candidate links. Preferably, links from which a distance of the remote vehicle 46 is larger than or equal to the link distance threshold value are eliminated from the set of candidate links, and only the links to which the remote entity is closer than the link distance threshold value are kept in the set of candidate links.
5. Create an initially empty list for containing a subset of the candidate links, wherein the list is to be filled based on an order according to a cost function defined in step 6.2.
6. Iterate through the set of candidate links and perform the following sub-steps in each iteration.
   6.1 Check if the end points of the current candidate link have an equivalent in the lists of nodes ahead and nodes behind in the map-matching container of the received message.
   6.2 If at least one equivalent node is found (there may be several equivalent nodes in the local digital map), a cost value is calculated, wherein the cost value is a function of the distance of a closest equivalent node distance for a first node behind and a distance of closest equivalent node for a first node ahead and a distance between the remote entity and the candidate link. (As an example, the cost function can be a sum of the three distances.)
   6.3 If no equivalent node is found either for the first node behind or first the node ahead in step 6.2, continue the iteration with a next candidate link. Otherwise, add the current candidate link along with its corresponding cost value to the list ordered by the cost value.
7. If the list defined in step 5 is not empty, return the candidate link with the lowest cost as the matching result and skip the further steps.

Alternatively, steps 5 to 7 can be implemented as follows:
5′. Create an initially empty list for containing a subset of the candidate links, wherein the list is to be filled based on an order according to a cost function defined in step 6.2.
6′. Iterate through the set of candidate links again and perform the following sub-steps.
   6′.1 Classify the end points of a current candidate link as a local node ahead and/or a local node behind based on the direction of motion of the remote vehicle 46.
   6′.2 Generate a straight extension of the current candidate link according to the directionality defined in the previous step.
   6′.3 Extract the nodes that span the straight extension obtained in the previous sub-step and keep only those nodes that have either more than two connecting links or exactly one connecting link. The first condition describes nodes where road junctions are located (junction nodes), while the second condition corresponds to nodes to which no more road connects (in the map segment currently kept in the memory).
   6′.4 Within the ordered list of nodes obtained in the previous sub-step, find the closest equivalent node both among the nodes behind and the nodes ahead and evaluating the same cost function as in step 6.2 with the distance of the closest equivalent node distance in the node pairs behind and the closest equivalent node distance in the node pairs ahead and the distance between the remote entity and the current candidate link. (It is to be noted that the number of node pairs to be checked in this step is larger than that of in step 5.)
   6′.5 (Optional) Iterate through the nodes within the map-matching container of the received message and check if any of the elements of the lists of the nodes ahead and of the nodes behind lie within the link distance threshold value from the links in the straight extension of the current candidate link. If matches are found, evaluate the same cost function as in step 6.2, but instead of the equivalent node distances, the lowest distances among the nodes ahead and nodes behind and the links in the straight extension are used.
   6′.6 If no equivalent node is found either among the nodes behind or the nodes ahead in step 6′.4 or no close link is found to the links in step 6′.5 (optional), continue the iteration with a next candidate link. Otherwise, add the current candidate link along with its corresponding cost value to the list ordered by the cost value.
7′. If the list defined in step 5′ is not empty, return the candidate link with the lowest cost as the matching result and skip the further steps.
8. If this step is reached, it means that no correspondence has been found between the local digital map and the map-matching result of the remote entity. Map-matching the remote entity against the local digital map by any map-matching algorithm available at the receiving entity 44.

The invention, furthermore, relates to a computer program product comprising instructions which, when the program is executed by a computer, cause the computer to carry out an embodiment of the method according to the invention.

The computer program product may be executable by one or more computers.

The invention also relates to a computer readable medium comprising instructions which, when executed by a computer, cause the computer to carry out an embodiment of the method according to the invention.

The computer readable medium may be a single one or comprise more separate pieces.

The invention is, of course, not limited to the preferred embodiments described in detail above, but further variants, modifications and developments are possible within the scope of protection determined by the claims. Furthermore, all embodiments that can be defined by any arbitrary dependent claim combination belong to the invention.

### LIST OF REFERENCE SIGNS

10 ego-vehicle
12 GNSS
14 RTKS
16 DR algorithm
18, 18′ map-matched objects database
20 ego positioning sub-system
22 ego-vehicle position
24 map provider
26, 26′ data communication channel
28,28′ digital map data
30 map-matching module
32, 32′ map-matching result
34 map-matching result sharing module
36, 36′ message
38 networking stack
40, 40′ message
42, 42′ data communication channel
44 receiving entity
46 remote vehicle
48 data communication channel
50 remote vehicle position
52 map-matching result verification module
54 first map provider
56 second map provider
58 map consolidation API
60 map-matching result sharing entity
62 infrastructure element

1. A system for sharing a map-matching result, comprising
a map-matching module adapted for
receiving a digital map data from a map provider,
receiving a location information,
performing a map-matching on the received location information using the digital map data, and
generating a map-matched location information, and
a map-matching result sharing module that is connected to the map-matching module, wherein the map-matching result sharing module is adapted for
receiving the map-matched location information from the map-matching module, and
assembling a message including the map-matched location information as a map-matching result to be shared.

2. The system according to claim 1, further comprising an ego-positioning sub-system connected to the map-matching module to provide location information of an ego-vehicle to the map-matching module.

3. The system according to claim 2, wherein the ego-positioning sub-system is in connection with a GNSS and/or an RTKS.

4. The system according to claim 2, wherein the ego-positioning sub-system is adapted to receive input from a DR algorithm.

5. The system according to claim 1, wherein the map-matching module is adapted to receive the location information from a remote vehicle.

6. The system according to claim 1, further comprising a map-matched objects database adapted for storing map-matched location information, wherein the map-matched objects database is connected to the map-matching module.

7. The system according to claim 6, wherein the map-matched objects database is in a bidirectional connection with the map-matching module.

8. The system according to claim 6, further comprising a map-matching verification module adapted for receiving map-matched location information from a remote vehicle and to verify compatibility of the received map-matched location information, and the map-matching verification module is connected to the map-matched objects database.

9. The system according to claim 1, further comprising a networking stack connected to the map-matching result sharing module to receive the message including the map-matched location information, wherein the networking stack is adapted to sharing a message with one or more receiving entities, wherein the message is assembled by the networking stack based on the message including the map-matched location information.

10. The system according to claim 9, wherein the networking stack is adapted to communicate on one or more networking protocols.

11. The system according to claim 9, wherein the networking stack is adapted to communicate with multiple receiving entities simultaneously.

12. The system according to claim 1, wherein the message assembled by the map-matching result sharing module is a CAM message or a BSM message.

13. A method for receiving a shared map-matched location information and matching the shared map-matched location information with a local map having a local map data source identifier by a receiving entity, wherein the local map comprises links and nodes, wherein the map-matched location information is received in a form of a message comprising
a map data source identifier, and
a link identifier corresponding to the map-matched location information,
the method comprising the steps of
comparing the map data source identifier with the local map data source identifier by a map-matching result verification module,
in case the map data source identifier and the local map data source identifier are compatible, returning the link identifier as a match of the received map-matching location information, and
in case the map data source identifier and the local map data source identifier are not compatible,
defining, in a definition step, a link distance threshold,
compiling a set of candidate links by selecting links within the link distance threshold from a location corresponding to the map-matched location information, and
iterating, in an iteration step, through each element of the set of candidate links to find a candidate link as the match of the received map-matching location information.

14. The method according to claim 13, characterized in that the comparison of the map data source identifier with the local map data source identifier is performed based on a predetermined compatibility table.

15. The method according to claim 13, characterized by performing map-matching on the local map of the map-matched location information received in case no match of the received map-matching location information is found.

16. The method according to claim 13, characterized by performing the following steps in the iteration step if the message included one or more containers containing a list of nodes ahead and/or a list of nodes behind:
classifying end points of a current candidate link as a local node ahead and/or as a local node behind, wherein the current candidate link is an element of the set of candidate links,
generating a straight extension of the current candidate link,
iterating through each node of the straight extension and checking whether any of the local nodes ahead and any of the local nodes behind have an equivalent in the list of nodes ahead and in the list of nodes behind, and if an equivalent is found, the current candidate link is returned as the match of the received map-matching location information.

17. The method according to claim 16, characterized by
defining, in the definition step, a node distance threshold, and
in the iteration step,
calculating a distance between the local nodes ahead and elements of the list of nodes ahead and a distance between the local nodes behind and elements of the list of nodes behind, and
considering any of the local nodes ahead and any of the local nodes behind being equivalent with an element of the list of nodes ahead and/or of the list of nodes behind if the distance between the local nodes ahead and elements of the list of nodes ahead and/or the distance between the local nodes behind and elements of the list of nodes behind is within the node distance threshold.

18. The method according to claim 17, characterized in that in case an equivalent of a node is found,
defining a cost function, and
calculating a cost value, wherein the cost value is a function of a distance of a closest equivalent node for a first node behind and a distance of closest equivalent node for a first node ahead and a distance between a remote entity and the current candidate link.

19. The method according to claim 18, characterized in that, the cost function is a sum of the distance of a closest equivalent node for a first node behind, the distance of closest equivalent node for a first node ahead and the distance between the remote entity and the current candidate link.

20. (canceled)

21. A non-transitory computer readable medium comprising instructions which, when executed by a computer, cause the computer to carry out the method of claim 13.
